(19) United States
(12) Patent Application Publication
(10) Pub. No.: US 2012/0313606 A1
(43) Pub. Date: Dec. 13, 2012

(54) METHOD FOR OPERATING SOFT START CIRCUIT AND DEVICES USING THE METHOD

(76) Inventors: Dong II JUNG, Suwon-si (KR); Yus KO, Yongin-si (KR); Tae Woo KWAK, Suwon-si (KR)

(21) Appl. No.: 13/489,849

(22) Filed: Jun. 6, 2012

(30) Foreign Application Priority Data
Jun. 9, 2011 (KR) 10-2011-0055387

(51) Int. Cl. G05F 1/10; G05F 3/16

(52) U.S. Cl. 323/283; 323/282; 323/313

(57) ABSTRACT

A soft start circuit is disclosed. The soft start circuit includes a reference voltage generator configured to generate a reference voltage, a switch connected between an output node of the reference voltage generator and an output node of the soft start circuit and configured to selectively provide an output signal in response to a switch control signal, a capacitor connected between the switch and a ground, and a current source configured to generate a current having a different level in each of a plurality of intervals to charge the capacitor.

### CROSS-REFERENCE TO RELATED APPLICATIONS

This application claims priority under 35 U.S.C. §119(a) to Korean Patent Application No. 10-2011-0055387 filed on Jun. 9, 2011, the entire contents of which are hereby incorporated by reference.

### BACKGROUND

Example embodiments of inventive concepts relate to a method for operating a soft start circuit to prevent damage of an electronic device induced by an inrush current, and/or devices capable of performing the method.

Inrush current is a momentary input current surge when power is provided to an electronic device. The inrush current may cause a malfunction of or damage to the electronic device. Thus, there is a demand for a soft start circuit to prevent the electronic device from being damaged by any inrush current.

### SUMMARY

According to an example embodiment, there is provided a soft start circuit including a reference voltage generator configured to generate a reference voltage, a switch connected between an output node of the reference voltage generator and an output node of the soft start circuit, and configured to selectively provide an output signal in response to a switch control signal, a current source configured to generate a current having a different level in each of a plurality of intervals; a capacitor connected to the switch, configured to charge based on the current, and configured to generate the switch control signal.

The capacitor is configured to generate the switch control signal in response to the current provided to the capacitor, such that the switch control signal has a different slope in each of the plurality of intervals. The switch is configured to turn on when the slope of the switch control signal reaches a transition point.

The current source includes a first current source configured to generate a first current in response to a control signal, a second current source configured to generate a second current in response to a bias signal and provide the second current to the capacitor in response to an inverted enable signal, and a control signal generator configured to generate the control signal according to an enable signal and the inverted enable signal, wherein the current is the sum of the first current and the second current.

According to an example embodiment, there is provided a regulator including the soft start circuit, an error amplifier configured to compare a signal output from the soft start circuit and a feedback signal, amplify a signal corresponding to a result of the comparison, and output an error signal, a power transistor configured to output an input voltage as a constant output voltage in response to the error signal, and a feedback circuit configured to distribute the voltage output from the power transistor and output the feedback signal.

According to an example embodiment, there is provided an electronic device including the regulator, a memory, and a processor wherein the output voltage output from the regulator is configured to be used as an operating voltage and control an operation of the memory.

According to an example embodiment, there is provided a method for operating a soft start circuit including generating a current having a different level in each of a plurality of intervals, generating a switch control signal having a voltage whose slope differs in each of the plurality of intervals based on the current provided to a capacitor, outputting an output reference voltage which is gradually increased in response to the switch control signal provided to a switch.

The generating a current includes determining whether or not a first current is generated by using a first current source operating in response to a control signal, generating a second current by using a second current source and determining whether or not the second current is provided to a capacitor in response to an inverted enable signal, and generating the control signal by using a control signal generator operating in response to an enable signal and the inverted enable signal, wherein the slope of the switch control signal is determined by the current which is the sum of the first current and the second current.

According to an example embodiment, there is provided a soft start protection circuit including, an input portion configured to receive an input voltage, an output portion configured to provide an output voltage at a output node, a switch controller configured to generate a switch control signal such that the switch control signal has a voltage which varies at a slope that differs in each of a plurality of intervals, and a switch electrically connected between the input portion and the output portion, and configured to selectively provide the output voltage in response to the switch control signal.

### BRIEF DESCRIPTION OF THE DRAWINGS

The above and other features and advantages of example embodiments will become more apparent by describing in detail example embodiments thereof with reference to the attached drawings in which:

FIG. 1 is a circuit diagram illustrating a start circuit according to an example embodiment of the present inventive concepts;

FIGS. 2A through 2D are timing diagrams illustrating a plurality of signals shown in FIG. 1;

FIG. 3 is a circuit diagram illustrating a current source shown in FIG. 1;

FIG. 4 is a timing diagram illustrating a plurality of signals shown in FIG. 3;

FIG. 5 is a flow chart illustrating a method for operating a soft start circuit according to an example embodiment of the present inventive concepts;

FIG. 6 is a schematic diagram of a regulator including the soft start circuit shown in FIG. 1 according to an example embodiment of the present inventive concepts;

FIG. 7 is a block diagram of a power management integrated circuit including the soft start circuit shown in FIG. 1;

FIG. 8 is a block diagram illustrating an example embodiment of an electronic device including the soft start circuit shown in FIG. 1;

FIG. 9 is a block diagram illustrating another example embodiment of an electronic device including the soft start circuit shown in FIG. 1; and

FIG. 10 is a block diagram illustrating yet another example embodiment of an electronic device including the soft start circuit shown in FIG. 1.

### DETAILED DESCRIPTION OF THE EMBODIMENTS

Example embodiments now will be described more fully hereinafter with reference to the accompanying drawings, in which example embodiments are shown. Example embodiments may, however, be embodied in many different forms and should not be construed as limited to the embodiments set forth herein. Rather, these example embodiments are provided so that this disclosure will be thorough and complete, and will fully convey the scope of example embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

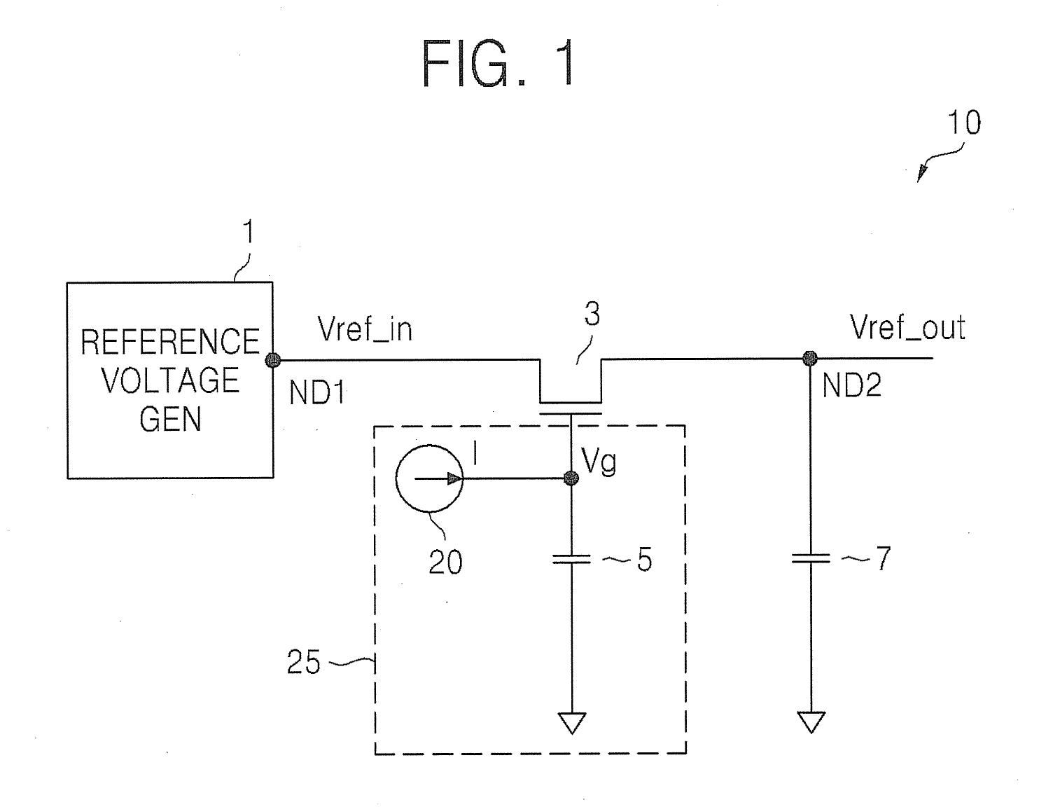

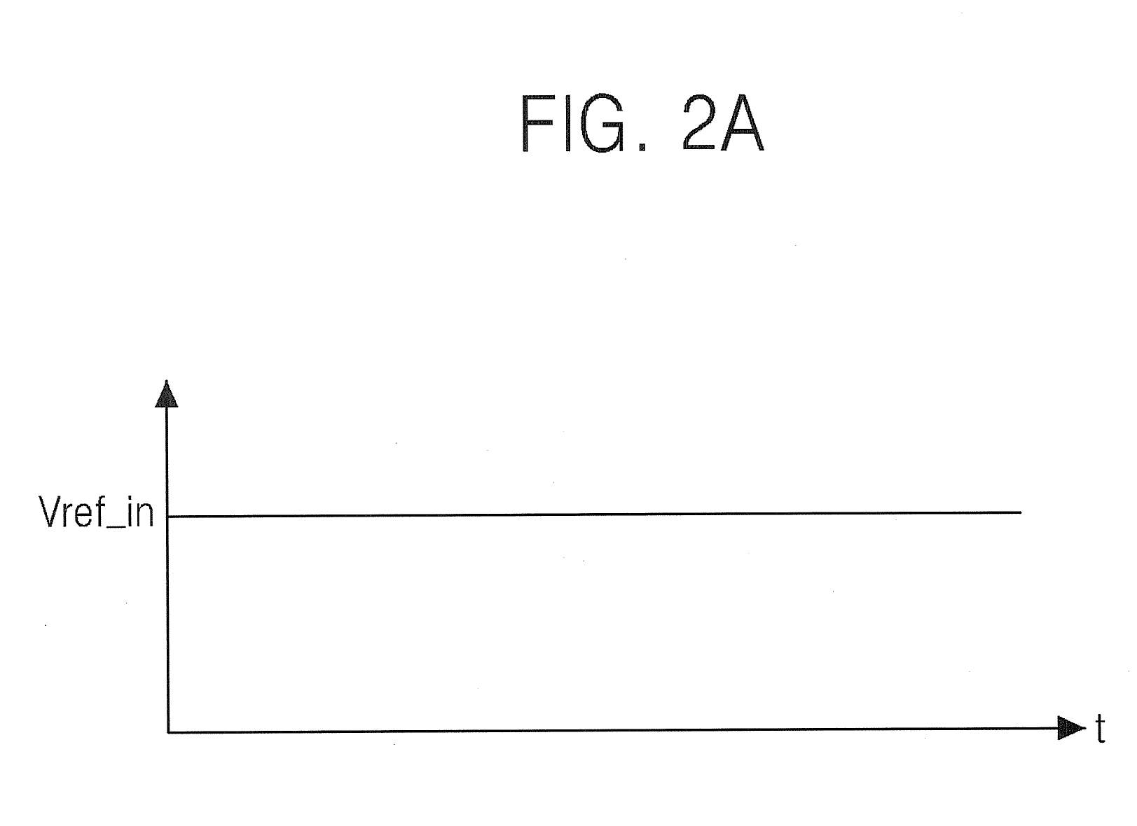

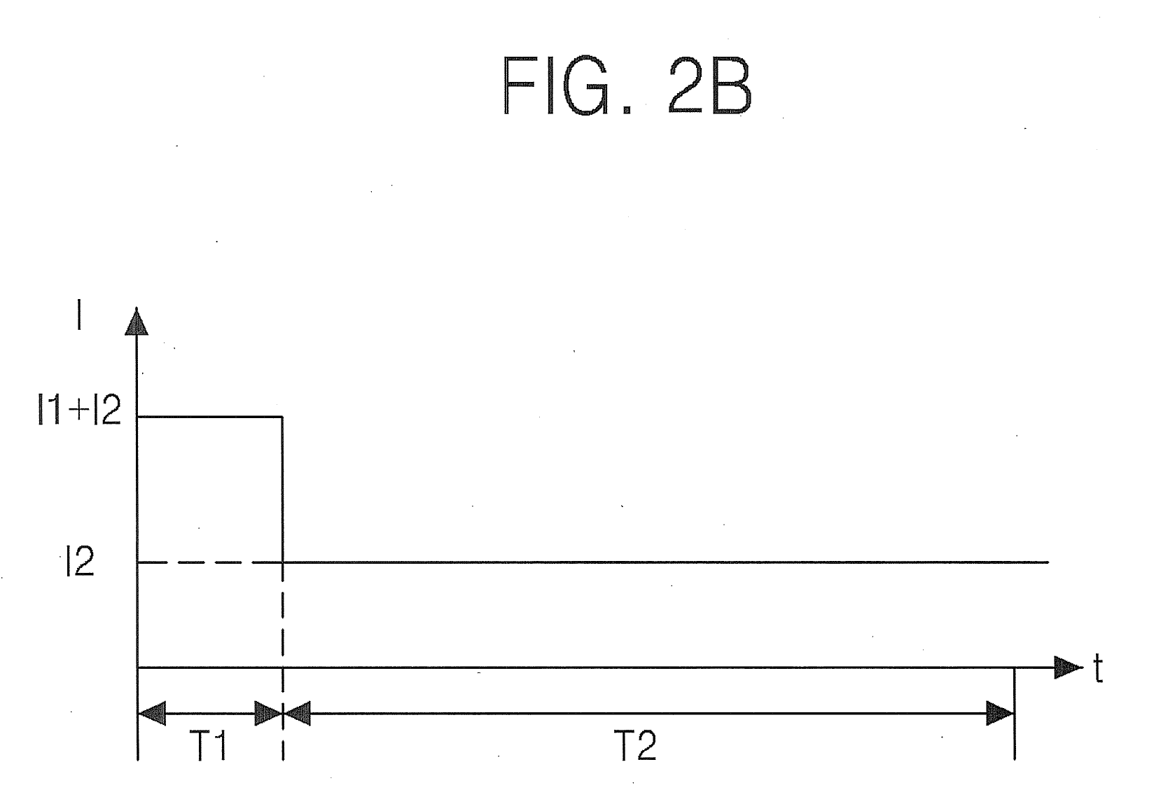

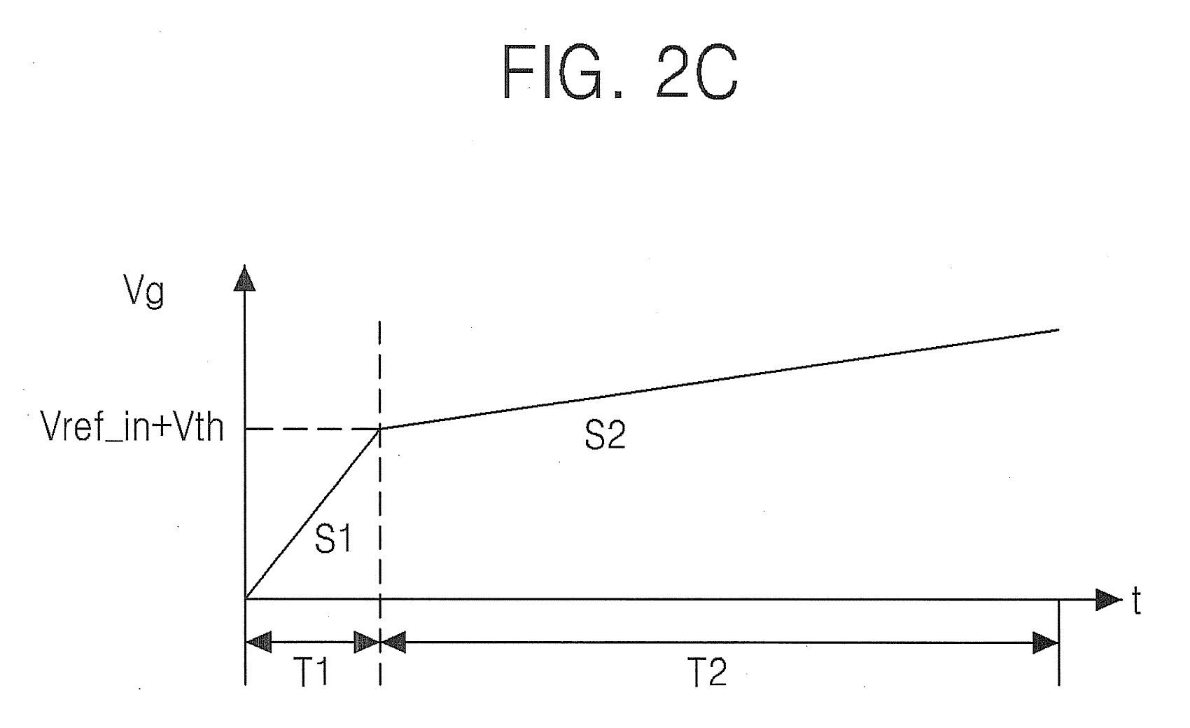

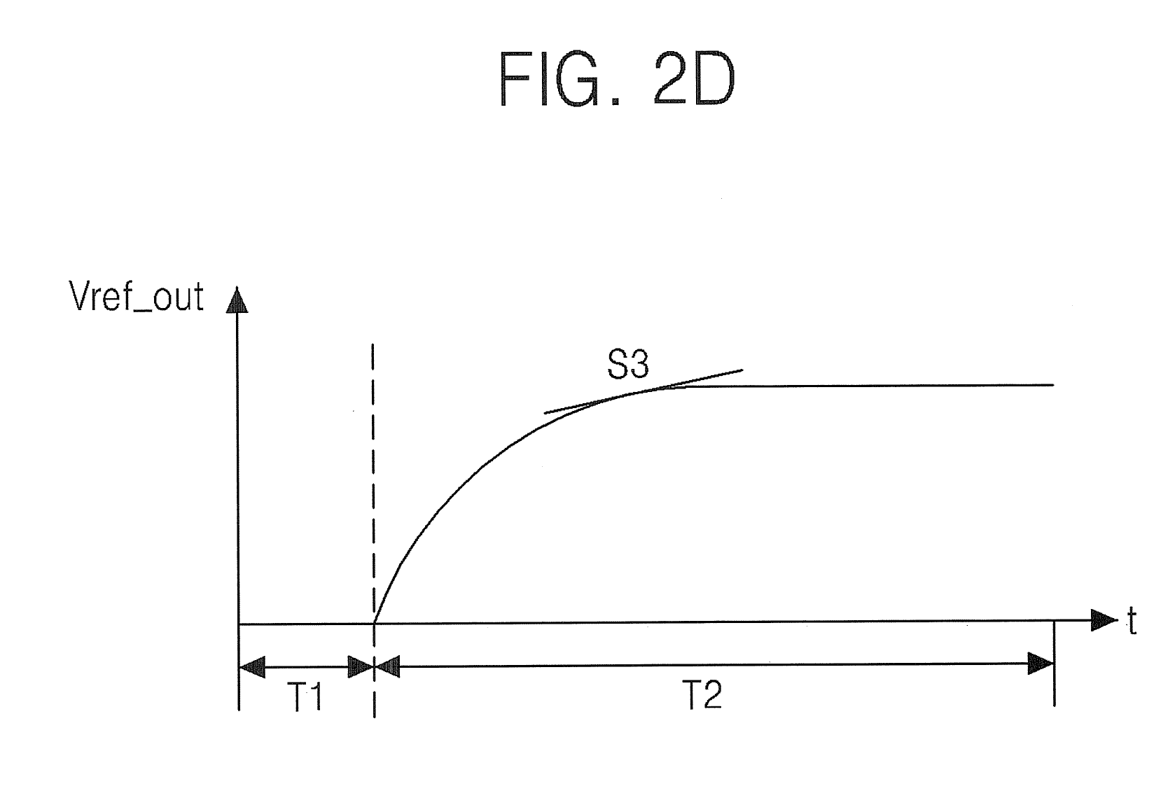

FIG. 1 is a circuit diagram of a soft start circuit according to an example embodiment. FIGS. 2(A)-2(D) are timing diagrams of a plurality of signals illustrated in FIG. 1. Referring to FIGS. 1 and 2, the soft start circuit 10 includes a reference voltage generator 1, a switch 3, and a switch controller 25 including a capacitor 5, and a current source 20.

The reference voltage generator 1 generates a certain reference voltage Vref_in shown in FIG. 2(A) As shown in FIG. 2(A), Vref_in is a relatively stable signal. However, when the reference voltage Vref_in is input to a regulator (not shown) directly, an inrush current or a ripple may occurr. The inrush current or the ripple may induce a malfunction of or damage to an electronic device (not shown). Accordingly, the soft start circuit 10 is desired.

The switch 3 is connected between an output node ND1 of the reference voltage generator 1 and an output node ND2 of the soft start circuit 10. The switch 3 may be implemented as an NMOS transistor. When the switch 3 is implemented as an NMOS transistor, the switch 3 is turned on when the switch 3 satisfies the following Equation 1.

Vg>Vref_in+Vth [Equation 1]

where Vg denotes a gate voltage of the NMOS transistor 3, Vref_in denotes a source voltage of the NMOS transistor 3, and Vth denotes a threshold voltage of the NMOS transistor 3.

Thus, the switch 3 is turned off in a first interval T1 of FIGS. 2(B)-2(D) and turned on in a second interval T2. The switch 3 is turned on at the transition point of a slope of a switch control signal Vg. When the switch 3 is turned off, resistance of the switch is infinite. Accordingly, an output reference voltage Vref_out of FIG. 2(D) begins to increase from the second interval T2.

The soft start circuit 10 is capable of controlling a start-up time since the output reference voltage Vref_out is increased starting from the second interval (T2).

Also, since as shown in FIG. 2(D) the slope (S3) is nearly 0 when the output reference voltage Vref_out has a final value, the possibility of a ringing is low, even though phase margins of the rest of the circuits in the regulator (not shown) are not enough to prevent ringing.

The capacitor 5 is connected between the switch 3 and a ground. The current source 20 generates a current I which has a different level in each of a plurality of intervals (T1 and T2) as shown in FIG. 2B. The current I in the interval T1 is the sum of a first current I1 and a second current I2, and the current I in the second interval T2 is a second current I2.

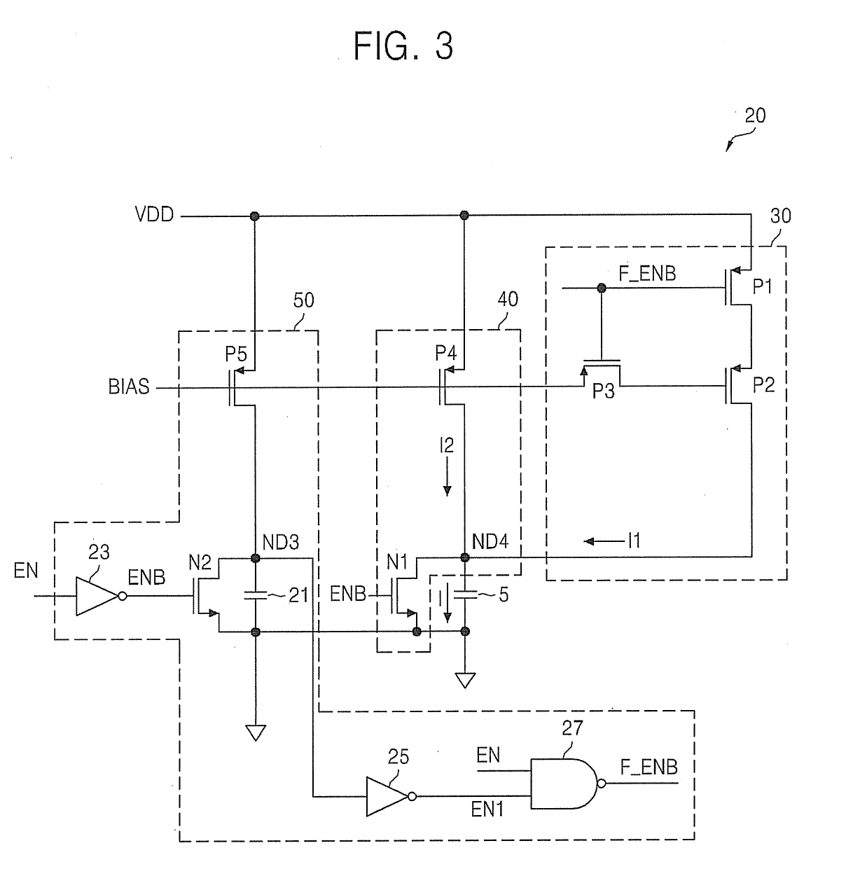

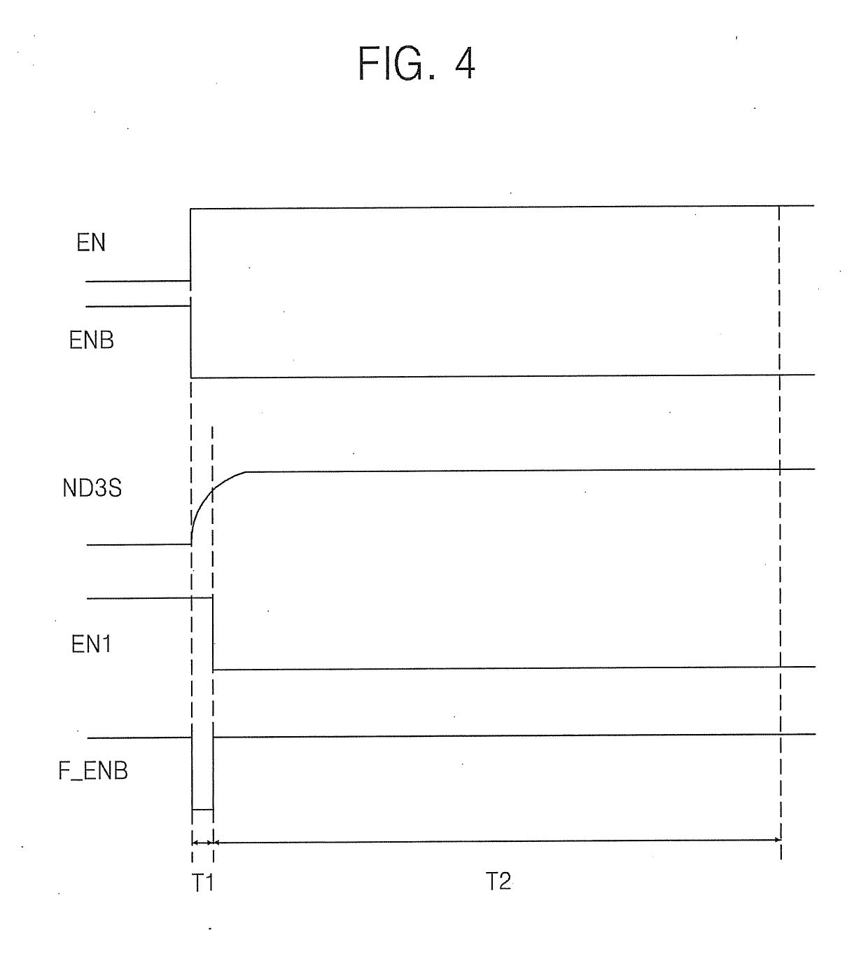

Regarding the current source 20, it will be described in FIGS. 3 and 4 in more details.

The switch 3 is controlled by the switch control signal Vg having a different slope S1 and S2 in each of the plurality of intervals T1 and T2 as shown in FIG. 2C. The switch control signal Vg is generated as the current I (I=I1 or I2) having a different level in each of the plurality of intervals T1, T2 is provided to the capacitor 5.

The switch 3 is controlled by the switch control signal Vg having a different slope S1 and S2 in each of the plurality of intervals T1 and T2. The switch control signal Vg has a first slope S1 in the first interval T1 and a second slope S2 in the second interval T2. For example, the first slope S1 is larger than the second slope S2. An output capacitor 7 maintains the output reference voltage Vref_out stably.

FIG. 3 is a circuit diagram of the current source shown in FIG. 1, and FIG. 4 is a timing diagram of a plurality of signals shown in FIG. 3. Referring to FIGS. 1 through 4, the current source 20 includes a first current source 30, a second current source 40, and a control signal generator 50. The first current source 30 determines whether or not a portion of the current I, that is, the first current I1, is generated based on a control signal F_ENB.

The first current source 30 includes two PMOS transistors P1 and P2 connected in series between a power line providing a power source VDD and a node ND4, and a PMOS transistor P3. A gate of the PMOS transistor P3 and a gate of the PMOS transistor P1 are connected with each other, and a drain of the PMOS transistor P3 and a gate of the PMOS transistor P2 are connected with each other. An operation of the PMOS transistor P1 is controlled by the control signal F_ENB.

Time delay of each signal EN, ENB, ND3S, EN1, and F_ENB shown in FIG. 4 is ignored. Referring to FIG. 4, the control signal F_ENB in the first interval T1 is low and the control signal F_ENB of the second interval T2 is high. Accordingly, the first current I1 flows through the PMOS transistor P1 in the first interval T1.

The PMOS transistor P1 is turned off in the second interval T2, and the first current I1 does not flow through the first current source 30. The second current source 40 includes a PMOS transistor P4 and an NMOS transistor N1 connected in series between the power line providing the power source VDD and a ground.

The capacitor 5 is connected between a node ND4 and the ground. An operation of the NMOS transistor N1 is controlled by an inverted enable signal ENB. Since the inverted enable signal ENB is low in both the first interval T1 and the second interval T2, the NMOS transistor N1 is turned off. Thus, the second current I2 is provided to the capacitor 5.

The current I which is the sum of the first current I1 and the second current I2 flows in the first interval T1, and only the second current I2 flows in the second interval T2.

The control signal generator 50 includes a PMOS transistor P5 and an NMOS transistor N2 connected in series between the power line providing the power source VDD and the ground, a capacitor 21 connected in parallel with the NMOS transistor N2, an inverter 23, an inverter 25, and a NAND gate 27.

The inverter 23 inverts an enable signal EN and outputs the inverted enable signal ENB. An operation of the NMOS transistor N2 is controlled by the inverted enable signal ENB. The inverted enable signal ENB is low in the first interval T1 and the second interval T2. When the inverted enable signal ENB is low, the NMOS transistor N2 is turned off. When the NMOS transistor N2 is turned off, the capacitor 21 is charged. When the capacitor 21 is charged, the signal ND3S of a node ND3 is shown in FIG. 4.

When the signal ND3S of the node ND3 increases from low to high, an output signal of the inverter 25 turns from high into low. The NAND gate 27 performs a NAND operation on the enable signal EN and the output signal EN1 of the inverter 25 and outputs the control signal F_ENB.

A bias voltage BIAS controls the PMOS transistor P4 and the PMOS transistor P5.

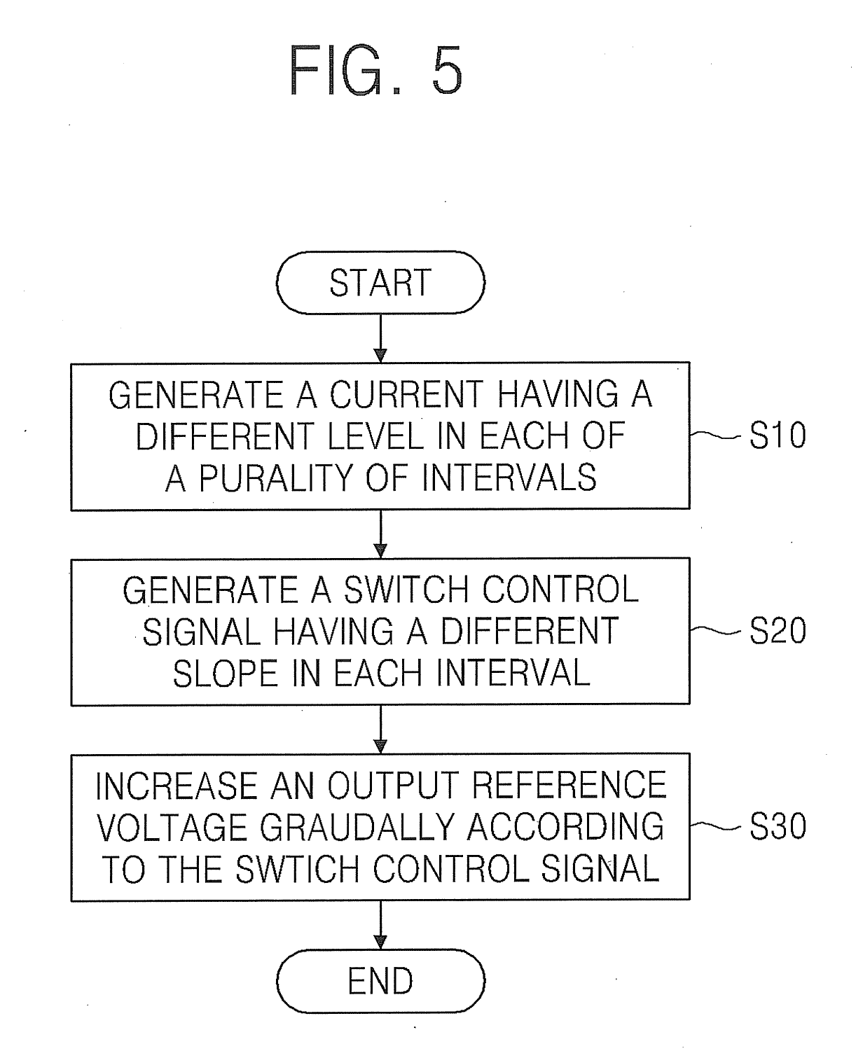

FIG. 5 is a flow chart illustrating a method for operating a soft start circuit according to an example embodiment of the present inventive concepts. Referring to FIGS. 1 through 5, a current source 20 may generate a current I, that is, I1 and I2, which may have a different level in each of a plurality of intervals T1 and T2 (S10).

As the current I is provided into a capacitor 5, a switch control signal Vg which may have a different slope S1 and S2 in each interval T1 and T2 is generated as shown in FIG. 2C (S20).

The soft start circuit 10 is configured to increase an output reference voltage Vref_out gradually in response to the switch control signal Vg as shown in FIG. 2D (S30) where the output reference voltage Vref_out begins to increase from the second interval T2.

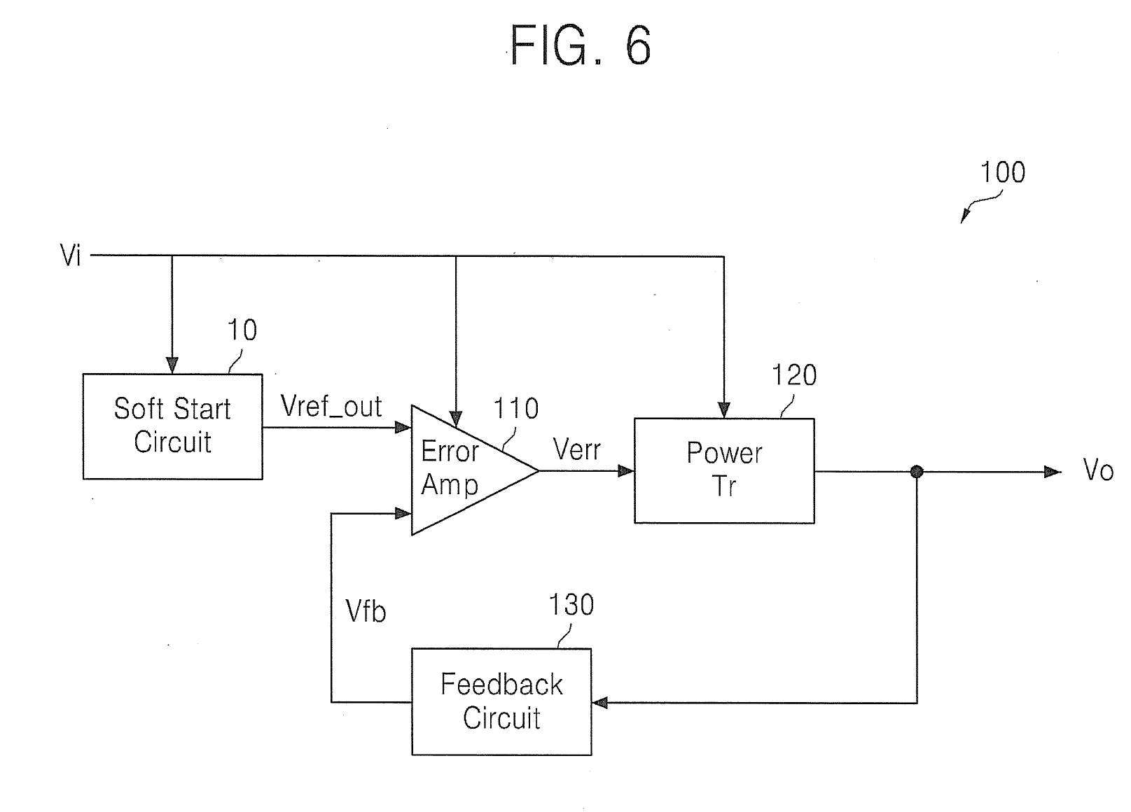

FIG. 6 is a schematic block diagram of a regulator including the soft start circuit shown in FIG. 1 according to an example embodiment of the present inventive concepts. Referring to FIGS. 1 through 6, the regulator 100 converts an input voltage Vi into a stable output voltage Vo and maintains a certain output voltage Vo. The regulator 100 shown in FIG. 6 may be implemented as a linear regulator.

The regulator includes the soft start circuit 10, an error amplifier 110, a power transistor 120, and a feedback circuit 130.

The soft start circuit 10 increases the output reference voltage Vref_out from the second interval T2, thus, a start-up time thereof is easily estimated.

The error amplifier 110 compares an output signal Vref_out output from the soft start circuit 10 and a feedback signal Vfb, amplifies a signal corresponding to a result of the comparison, and outputs the same as an error signal Verr.

The power transistor 120 outputs an input voltage Vi as a constant output voltage Vo in response to the error signal Verr. The input voltage Vi may be provided from a battery (not shown) or power pack units. The input voltage Vi is provided to the soft start circuit 10 and the error amplifier 110.

The feedback circuit 130 distributes the voltage Vo output from the power transistor 120 and outputs the feedback signal Vfb. For example, the feedback circuit 130 may include a voltage divider. In some embodiments, the soft start circuit 10 may be included in a switching regulator.

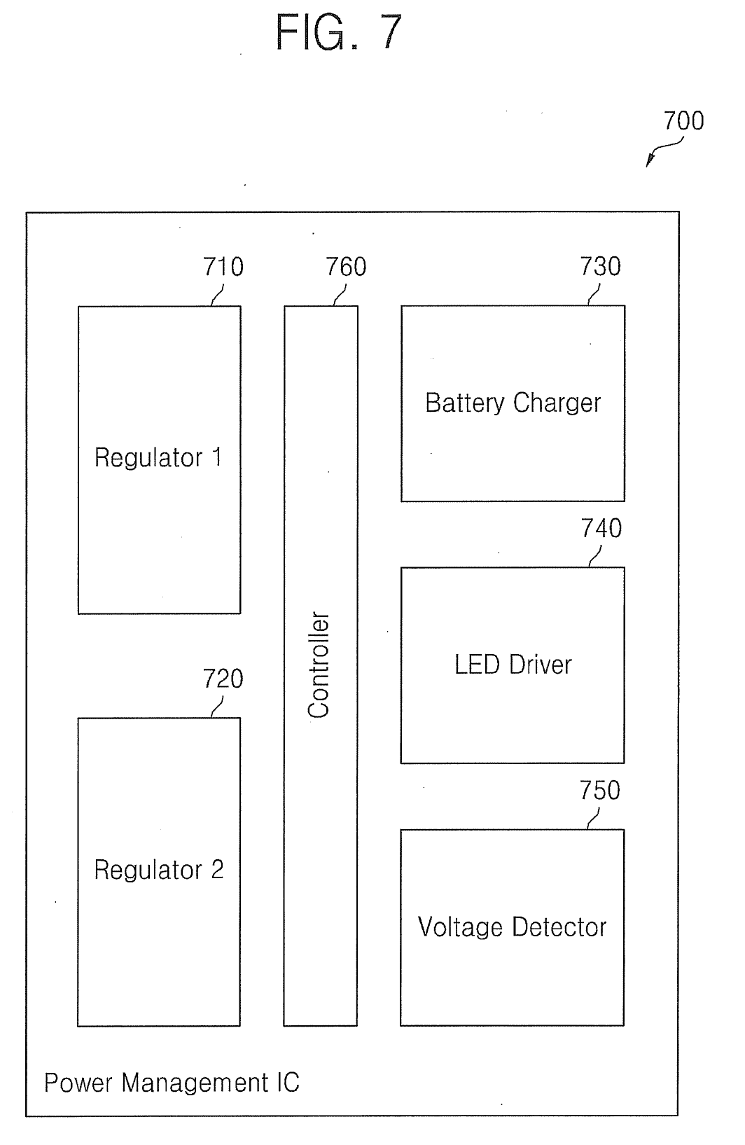

FIG. 7 is a block diagram of a power management IC including the soft start circuit shown in FIG. 1. Referring to FIGS. 1 through 7, the power management IC 700 is an integrated circuit for managing electric power. The power management IC 700 is used for electronic devices such as mobile phone, PMP (Portable Multimedia Player), and the like.

The power management IC 700 includes at least one regulator (for example, 710, or 720). The regulator(s) 710 and/or 720 provide power to components of an electronic device (not shown). The regulator(s) 710 and/or 720 include the soft start circuit 10 shown in FIG. 1. The regulator 710 may be a linear regulator 100 shown in FIG. 6, and the regulator 720 may be a switching regulator.

According to example embodiments, the power management IC 700 may include various components, for example, the power management IC 700 may include a battery charger 730, an LED driver 740, a voltage detector 750, or a controller 760.

The battery charger 730 may charge a battery (not shown) under the control of the controller 760. The LED driver 740 may operate an LED of the electronic device under the control of the controller 760. The voltage detector 750 is a sensor capable of detecting voltage of the electronic device. The controller 760 may further control an operation of the regulator(s) 710 and/or 720.

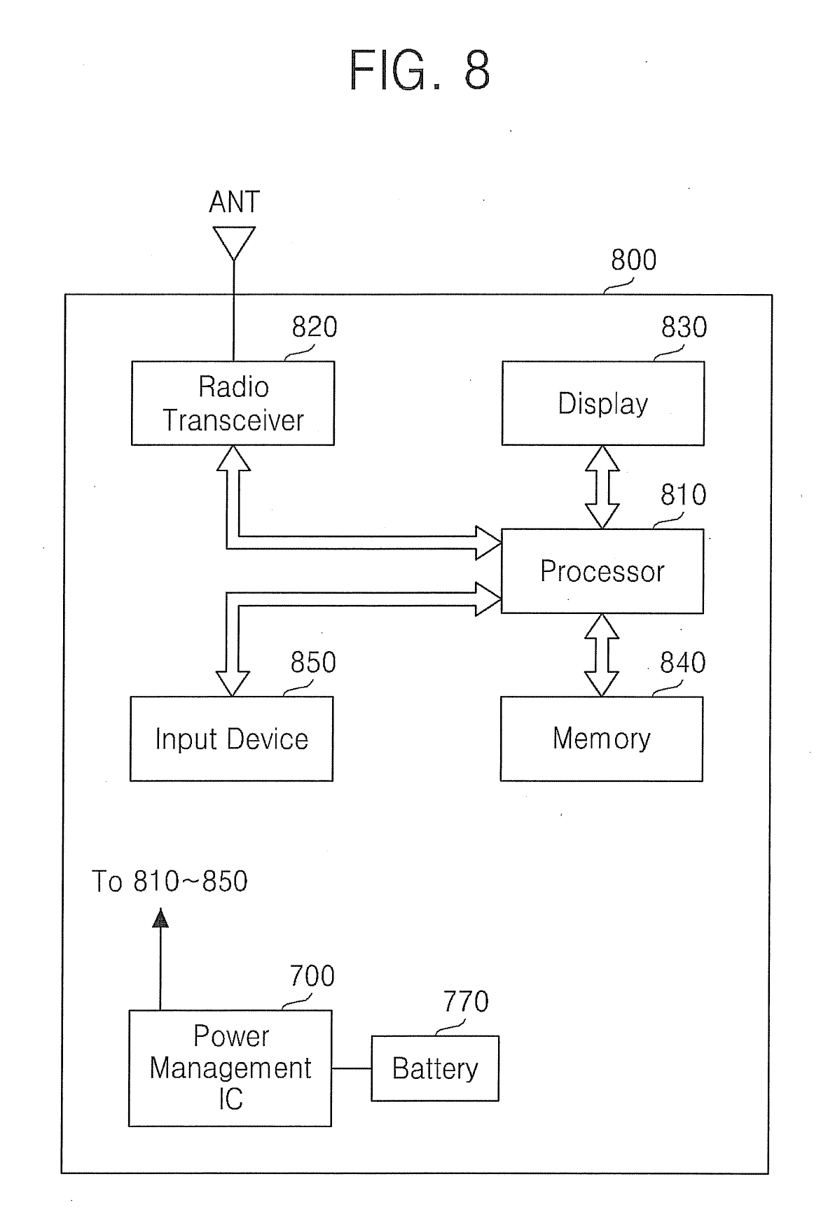

FIG. 8 is an example embodiment of an electronic device including the soft start circuit shown in FIG. 1. Referring to FIGS. 1 through 8, the electronic device 800, for example, cellular phone, smart phone, or tablet PC, includes the power management IC 700 and a battery 770. The power management IC 700 is provided power from the battery 770 and is configured to manage power of a processor 810, a wireless transmitter-receiver 820, a display 830, a memory 840, or an input device 850. The power management IC 700 includes the soft start circuit 10 shown in FIG. 1.

The wireless transmitter-receiver 820 may transmit or receive a radio signal through an antenna ANT. For example, the wireless transmitter-receiver 820 may convert the radio signal received through the antenna ANT into a signal that the processor 810 may process. Accordingly, the processor 810 may process the signal output from the wireless transmitter-receiver 820 and store the processed signal to the memory 840 or display the processed signal through the display 830.

The wireless transmitter-receiver 820 may convert the signal output from the processor 810 into a radio signal and output the converted radio signal to the outside through the antenna ANT.

The input device 850 is a device capable of inputting a control signal for controlling an operation of the processor 810 or a data to be processed by the processor 810, and may be implemented as a pointing device such as touch pad or computer mouse, a key pad, or a key board.

The processor 810 may control the display 830 to display a data output from the memory 840, a radio signal output from the wireless transmitter-receiver 820, or a data output from the input device 850.

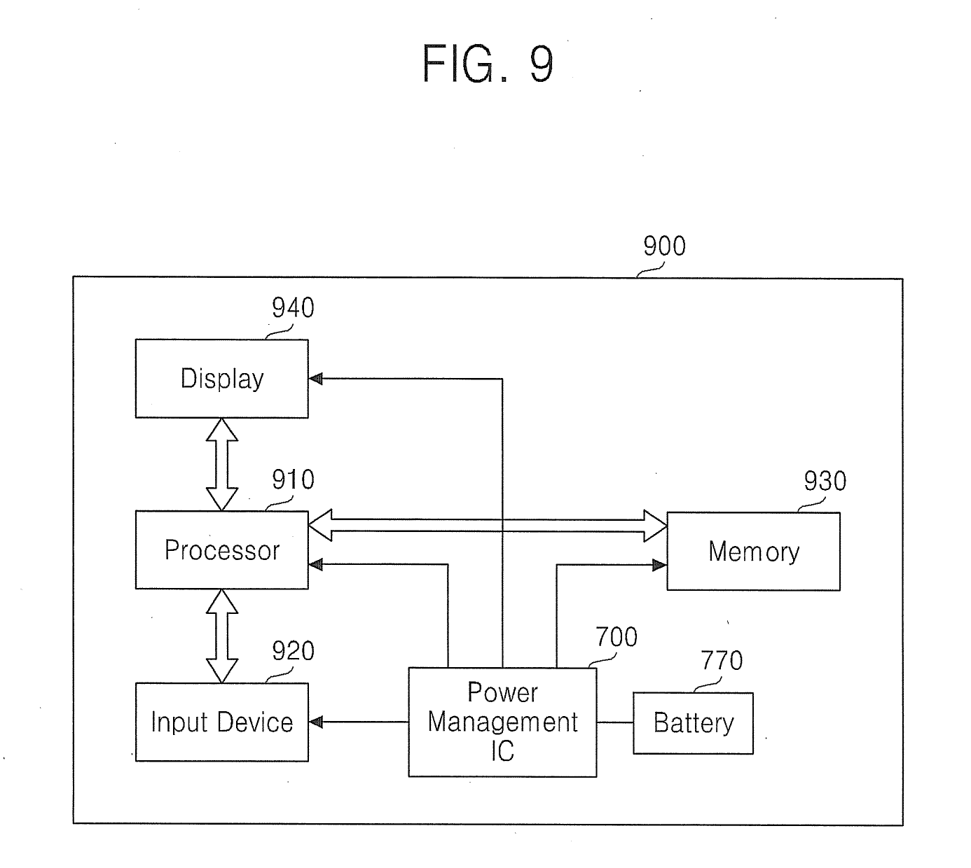

FIG. 9 is a block diagram illustrating another example embodiment of an electronic device including the soft start circuit shown in FIG. 1. Referring to FIGS. 1 through 7, and 9, an electronic device 900 may be implemented as PC (Personal Computer), tablet computer, net-book, e-reader, PDA (Personal Digital Assistant), PMP (Portable Multimedia Player), MP3 player, or MP4 player, and the electronic device 900 includes a power management IC 700 and a battery 770.

The power management IC 700 is provided power from the battery 770 and may manage power of a processor 910, an input device 920, a memory 930, or a display 940. The power management IC 700 includes the soft start circuit 10 shown in FIG. 1.

The electronic device 900 may include the processor 910 to control the general operation of the electronic device 900. The processor 910 may display a data stored to the memory 930 according to an input signal generated from the input device 920 through the display 940. For example, the input device 920 may be implemented as a pointing device such as touch pad or computer mouse, a key pad, or a key board.

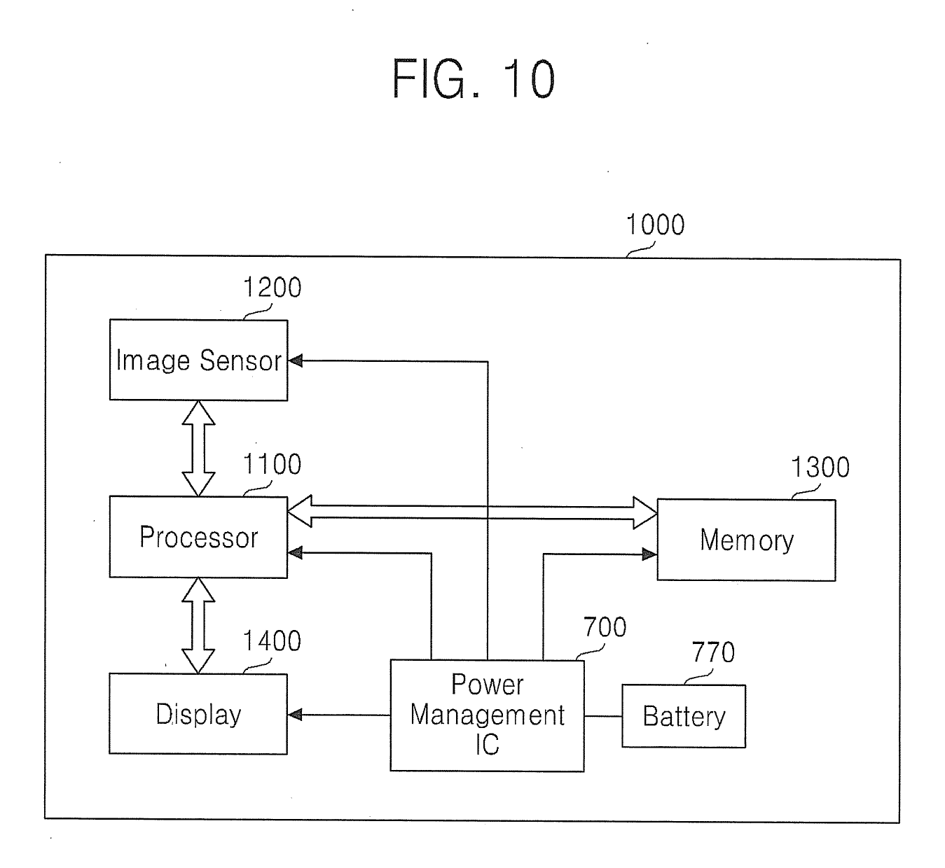

FIG. 10 illustrates yet another example embodiment of an electronic device including the soft start circuit shown in FIG. 1. Referring to FIGS. 1 through 7, and 10, the electronic device 1000 may be implemented as a digital camera and includes a power management IC 700 and a battery 770.

The power management IC 700 is provided power from the battery 770 and may manage power of a processor 1100, an image sensor 1200, a memory 1300, or a display 1400. The power management IC 700 includes the soft start circuit 10 shown in FIG. 1.

The image sensor 1200 of the electronic device 1000 may convert an optical signal into a digital signal, and the converted digital signal may be stored to the memory 1300 or displayed through the display 1400 under the control of the processor 1100. Also, the digital signal stored to the memory 1300 may be displayed through the display 1400 under the control of the processor 1100.

As described above, the method for operating the soft start circuit and devices capable of performing the method according to example embodiments of the present inventive concepts has effects of preventing an inrush current by using the switch control signal having a different slope in each interval and providing the reference voltage to the error amplifier without rippling.

While example embodiments have been particularly shown and described with reference to example embodiments thereof, it will be understood by those of ordinary skill in the art that various changes in forms and details may be made therein without departing from the spirit and scope of example embodiments as defined by the following claims.

What is claimed is:

1. A soft start circuit comprising:
a reference voltage generator configured to generate a reference voltage;
a switch connected between an output node of the reference voltage generator and an output node of the soft start circuit, and configured to selectively provide an output signal in response to a switch control signal;
a current source configured to generate a current having a different level in each of a plurality of intervals; and
a capacitor connected to the switch, configured to charge based on the current, and configured to generate the switch control signal.

2. The soft start circuit of claim 1, wherein the capacitor is configured to generate the switch control signal in response to the current provided to the capacitor, such that the switch control signal has a different slope in each of the plurality of intervals.

3. The soft start circuit of claim 2, wherein the switch is configured to turn on when the slope of the switch control signal reaches a transition point.

4. The soft start circuit of claim 1, wherein the current source comprises:
a first current source configured to generate a first current in response to a control signal;
a second current source configured to generate a second current in response to a bias signal and provide the second current to the capacitor in response to an inverted enable signal; and
a control signal generator configured to generate the control signal according to an enable signal and the inverted enable signal,
wherein the current is the sum of the first current and the second current.

5. A regulator comprising:
the soft start circuit of claim 1;
an error amplifier configured to compare the output signal and a feedback signal, amplify a signal corresponding to a result of the comparison, and output an error signal;
a power transistor configured to output an input voltage as a constant output voltage in response to the error signal; and
a feedback circuit configured to distribute the voltage output from the power transistor and output the feedback signal.

6. The regulator of claim 5, wherein the switch is controlled by a switch control signal which has a voltage with a different slope in each of the plurality of intervals, wherein the switch control signal is generated in response to the current provided to the capacitor.

7. The regulator of claim 5, wherein the switch is configured to turn on when the slope of the voltage of the switch control signal reaches a transition point.

8. The regulator of claim 5, wherein the current source comprises:
a first current source configured to generate a first current in response to a control signal;
a second current source configured to generate a second current in response to a bias signal and provide the second current to the capacitor in response to an inverted enable signal; and
a control signal generator configured to generate the control signal according to an enable signal and the inverted enable signal,
wherein the current is the sum of the first current and the second current.

9. An electronic device comprising:
the regulator of claim 5;
a memory; and
a processor, wherein the output voltage output from the regulator is configured to be used as an operating voltage and control an operation of the memory.

10. The electronic device of claim 9, wherein the electronic device further includes a wireless transceiver configured to transmit or receive a radio signal under the control of the processor, and the electronic device is a wireless communicating device.

11. The electronic device of claim 9, wherein the electronic device further includes an image sensor configured to generate an image signal from an optical signal under the control of the processor, and the electronic device is a digital camera.

12. The electronic device of claim 9, wherein the switch is controlled by a switch control signal which has a voltage with a different slope in each of the plurality of intervals, wherein the switch control signal is generated in response to the current provided to the capacitor.

13. The electronic device of claim 9, wherein the current source comprises:
a first current source configured to generate a first current in response to a control signal;
a second current source configured to generate a second current in response to a bias signal and provide the second current to the capacitor in response to an inverted enable signal; and
a control signal generator generating the control signal according to an enable signal and the inverted enable signal.

14. A method for operating a soft start circuit comprising:
generating a current having a different level in each of a plurality of intervals;
generating a switch control signal having a voltage whose slope differs in each of the plurality of intervals based on the current provided to a capacitor; and
outputting an output reference voltage which is increased gradually in response to the switch control signal provided to a switch.

15. The method of claim 14, wherein the generating the current comprises:
determining whether or not a first current is generated by using a first current source operating in response to a control signal;
generating a second current by using a second current source operating in response to a bias signal and determining whether or not the second current is provided to a capacitor in response to an inverted enable signal; and
generating the control signal by using a control signal generator operating in response to an enable signal and the inverted enable signal,
wherein the slope of the switch control signal is determined by the current which is the sum of the first current and the second current.

16. A soft start protection circuit, comprising:
an input portion configured to receive an input voltage;
an output portion configured to provide an output voltage at a output node;
a switch controller configured to generate a switch control signal such that the switch control signal has a voltage which varies at a slope that differs in each of a plurality of intervals; and
a switch electrically connected between the input portion and the output portion, and configured to selectively provide the output voltage in response to the switch control signal.

17. The soft start circuit of claim 16, wherein the switch controller includes,
a current source configured to generate a variable current that varies between a plurality of levels in each of a plurality of intervals, and
a capacitor configured to receive the variable current and output the switch control signal whose voltage varies at a slope that differs in each of the plurality of intervals.

18. The soft start circuit of claim 17, wherein the current source comprises:
a control portion including,
an inverter configured to perform an inversion operation on an enable signal to produce an inverted enable signal,
a second switch electrically connected in parallel with a control capacitor and configured to selectively provide a voltage signal in response to the inverted enable signal, and
a NAND gate, configured to perform a NAND operation on the enable signal and an inverse of the voltage signal to produce a control signal;
a first switching portion configured to selectively provide a first current in response to the control signal; and
a second switching portion configured to selectively provide a second current in response to a bias signal and the inverted enable signal, wherein
the variable current output by the current source varies between the first current and the sum of the first and second currents.

19. A regulator comprising:
the soft start circuit of claim 18;
an error amplifier configured to generate an amplified error signal corresponding to a result of comparing the soft circuit output signal and a feedback signal;
a power transistor configured to output an output voltage in response to the error signal; and
a feedback circuit configured to supply the feedback signal corresponding to a portion of the output voltage.

20. An electronic device comprising:
the regulator of claim 19; and
a memory, wherein the output voltage output from the regulator is configured to be used as an operating voltage and control an operation of the memory.
